(19) United States
(12) Patent Application Publication
(10) Pub. No.: US 2008/0226421 A1
(43) Pub. Date: Sep. 18, 2008

(54) Locking Assembly

(76) Inventors: Dickory Rudduck, Chicago, IL (US); Lee David Blattmann, New South Wales (AU); Geoffrey David Sizer, Chicago, IL (US)

Correspondence Address: TELEZYGOLOGY, INC., 520 W. ERIE STREET, SUITE 210, CHICAGO, IL, 60654, US

(21) Appl. No.: 12/063,909

(22) PCT Filed: Aug. 16, 2006
(86) PCT No.: PCT/AU2006/001168

§ 371 Date: Feb. 15, 2008

Related U.S. Application Data
(60) Provisional application No. 60/708,617, filed on Aug. 16, 2005.
(60) Provisional application No. 60/821,063, filed on Aug. 1, 2006.

(51) Int. Cl. F16B 19/02; F16B 21/18

(52) U.S. Cl. 411/356

(57) ABSTRACT

The invention provides a locking assembly (2) suitable for use in locking an aircraft seat in an upright position in an aircraft, for example. The locking assembly (2) includes a locking stud (10) having a locking cavity (12) and an aperture (14) for receiving the locking stud (10). A locking means (18) engages the locking cavity (12) when the locking stud (10) is received in the aperture (14). The locking assembly (2) also includes an unlocking means, which includes material adapted to contract when activated, such as shape memory alloy wire, to allow for disengagement from the locking cavity (12). The locking stud (10) is guided towards the aperture (14) by a locking stud guide (20).

### FIELD OF THE INVENTION

This invention relates to a locking assembly. While the locking assembly of the invention may have wide application, including in any door or lock situation, the description below will focus on locking assemblies used in the aerospace industry, especially those found in passenger seats or storage compartments of airplanes. However, it is to be understood that the invention is not limited to these applications.

### BACKGROUND OF THE INVENTION

In airplanes, passenger seats are an extremely important safety feature. While seats have been designed to afford a passenger a degree of comfort, they must still provide safety while travelling. As a result, while a passenger may recline a seat while travelling at the cruising altitude in safe weather conditions, passengers must sit at an upright position during take-off, while taxiing, while landing, or while travelling in inclement weather.

In an effort to provide passengers with safe yet comfortable seats, airplanes have allowed passengers to control their own seat positions. In the event that seats should not be reclined for passenger safety, airline crews generally make announcements requesting that all seatbacks are returned to their upright position and then the flight crew makes a visual check to ensure that all passengers are seated properly. The problem with this way of inspecting the passenger seats is that there is always room for human error. It is possible that a seat is simply overlooked visually and not properly in place. Also, it is possible for a passenger to put his/her seat in the upright position for the check, but then recline the seat after the inspection, thereby compromising safety.

Some current passenger seats use an electromagnetic actuator for ensuring that a seat is properly secured in crucial times for safety. However, users of these locks have found them to use excessive power and to be extremely heavy, two characteristics that are not desirable for airline travel. Airplanes must worry about weight for the safety of the plane and adding weight to the airplane before passengers board and luggage is loaded is an undesirable feature. Furthermore, the use of excessive power is a drain on an airplane's limited resources while in the air. As a result, airlines have a demand for a locking that is lighter, power-saving, easy to maintain, and safe from common contamination.

Typical storage units in an airplane utilize mechanical or electro-mechanical locking mechanisms. The latch generally consists of a mechanism which engages a male pin or staple when the door is closed. In the closed position the latch remains engaged to the male portion. To release the door, a user simply lifts the latch handle or, in the case of an electromagnetic latch, presses a switch and the door is released. While these types of systems have been successful in keeping items stowed during travel, there have been problems. There is a considerable amount of movement between the door and the cabinet during flight which leads to alignment problems between the mechanism and the pin.

Current locking mechanisms for seats and overhead bins also have the problem of debris, water, or other contaminants interfering with the locking motion. The locks are open to the elements and are prone to suffer damage due to these contaminants. As a result, a lock may not fit together properly or as securely as it should. A lock that is not secure can cause problems for passenger safety and can cause problems for the airplane in terms of maintaining these locks. Failure of the lock mechanism, control system or power supply can prevent the lock from assuming the safe condition. Once a lock is damaged or has failed, passenger safety is compromised and extensive repairs are often likely, resulting in higher costs for the airline and, eventually, the passengers.

### SUMMARY OF THE INVENTION

This invention aims to solve or at least alleviate the above-mentioned problems in a variety of ways. First of all, the locking assembly of the invention has a guide to assist in alignment of the locking mechanism and the pin. The locking assembly of the invention can provide a lock for the passenger seat or storage bin that is auto-aligned. This auto-align feature leaves no scope for the lock to be secured improperly, leaving the lock vulnerable to failure or incorrect positioning.

Next, the locking assembly of the invention may not require a physical access to the connection to secure the overhead bin. The locking assembly may activate remotely, without physical operation by the user or through hard wiring, and may use software to report that the overhead bin is secure. The technology may effectively enable software controlled assembly, disassembly, maintenance and access, thereby making this locking assembly an “intelligent” locking assembly.

The invention may also incorporate automatic monitoring of seat status and overhead bin status, so that a seat or bin which is unsecured during a safety-critical phase of flight can be reported to a central location, to allow cabin crew to take corrective action.

This invention is also unique in its solution of the above-mentioned problems in that in one embodiment it provides a sealed locking assembly. The locking assembly may utilize a relationship that never allows for the relevant parts to fully disengage from each other. This sealed relationship may prevent debris or other contaminants, such as dust or water, from interfering with the locking assembly function.

This invention is also capable of significantly reducing the weight and power consumption compared to prior art electromagnetic actuators, while being able to sense errors and report problems to the user. It can also enhance passenger comport by providing silent operation.

Broadly, this invention provides a locking assembly comprising:
a locking stud having a locking cavity;
an aperture for receiving the locking stud;
a locking means adapted to engage the locking cavity of the locking stud when received in the aperture;
an unlocking means comprising material adapted to contract when activated to allow for disengagement from the locking cavity; and
a locking stud guide adapted to guide the locking stud towards the aperture.

The locking stud may be chosen from a large range of suitable shapes. As one example, the locking stud may be generally circular in cross section, tapering in towards the base. The locking stud may be formed integrally with or attached to an element to be fastened. The attachment may be by adhesion, clipping or other suitable means.

The locking cavity may take any suitable form, but preferably is a groove around the perimeter of the locking stud.

In a preferred embodiment, the locking stud is part of a locking assembly as disclosed in International Patent Specification No. WO 2005/047714, the contents of which are imported herein by reference. Particular reference is made to the second aspect of the invention in the imported specification and to FIGS. 17 to 33, as well as to the description relating to the embodiments in those Figures.

In particular, it is preferred that the locking means has a plurality of teeth surrounded by a rotatable shuttle (called herein the “rotatable shuttle system”), as disclosed in the International Specification. However, it is to be understood that the invention is not limited to this type of locking assembly.

The material adapted to contract when activated is preferably shape memory alloy wire. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that sold under the name Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, an aircraft or automobile. It is also within the scope of this invention that the activation is initiated by remote means, such as a hand held tool operating through the use of any suitable form of energy, including microwave, electromagnetic, magnetic, sonic, infra-red, radio frequency and so on.

The scope of the invention is not necessarily limited to the use of shape memory alloy. Other material may also be useful. Also, while activation may take place through heating, other means of activation may be suitable and are within the scope of this invention.

The aperture is preferably formed centrally in a body, which may house the teeth and the shuttle when the rotatable shuttle system is used. The aperture is preferably of the same shape as the cross sectional shape of the locking stud, for example, circular. The aperture may take any other suitable shape.

If the locking stud is designed with a taper, it can be pushed into the aperture and be engaged without the need for any activation of the material. When the rotatable shuttle system is used, the taper on the locking stud can serve to form a ramp, pushing the teeth apart until they snap into the groove, being the locking cavity. In this configuration, the locking assembly is engaged. To disengage the locking assembly, it is necessary to activate the material so that it contracts and rotates the shuttle so that the teeth or other locking means are pulled out of engagement with the groove.

In the preferred embodiment, the material adapted to contract when activated is shape memory alloy wire which contracts by the application of suitable energy to reach the necessary temperature to cause the locking assembly to move from the locking position to the unlocking position. A second shape memory alloy wire may be similarly connected in order to cause the locking assembly to move from the unlocking position to the locking position.

In the preferred embodiment where the locking assembly has the rotatable shuttle system, the material adapted to contract when activated is wound around the shuttle, being attached at one end to the shuttle and at the other to a non-rotatable part of the locking assembly, such as a body for the locking assembly. In the preferred embodiment, the material adapted to contract when activated is shape memory alloy wire which contracts by the application of suitable energy to reach the necessary temperature to rotate the shuttle from the locking position to the unlocking position. A second shape memory alloy wire may be similarly connected to the shuttle in order to rotate it from the unlocking position to the locking position.

In one embodiment, the locking stud is slidable within the locking stud guide, which can guide the locking stud towards and away from the aperture. The locking stud guide preferably fits closely around the locking stud and provides a sealing relationship with the locking stud, to prevent contaminants from entering the locking assembly. If the locking stud is circular in cross section, then preferably the guide is tubular.

It is further preferred that a seal is mounted on the locking stud to contact inner walls of the guide to assist in sealing the locking assembly from contact with contaminants.

In a preferred embodiment, the locking stud is held captive by the guide so that the locking stud cannot disengage completely from the guide. This may be effected in any suitable manner.

In a particularly preferred embodiment, the locking stud is attached to or activated by a piston, the guide forming a housing in which the piston and locking stud are slidable towards and away from the aperture. Preferably, a locking strut inside the piston fits closely around the locking stud and preferably provides a sealing relationship with the locking stud, to prevent contaminants from entering the fastener assembly. If the locking stud is circular in cross section, then preferably the strut is tubular.

In this embodiment, the piston acts as a dampener as well as a shock absorber to aid in the control of, for example, opening the door to the storage unit. It may be counter balanced to be able to balance a set weight load to additionally control movement. The counter balance may comprise a spring, small weights, or other mechanisms that one skilled in the art may recognize as a counter balance.

When the locking stud is disengaged, the locking strut applies pneumatic dampening on the opening stroke. Upon the closing stroke to engage the locking stud, there is minimal resistance.

In a preferred embodiment, the locking stud is held captive by the pressure created by the piston so that the locking stud cannot disengage completely from the guide. This may be effected in any suitable manner.

In another embodiment, the locking stud guide is designed to align the locking stud only when the locking stud is relatively close to the aperture. In this embodiment, the locking stud guide may take the form of a cone or ramp, for example, to enable the locking stud to be captured and forced into correct alignment with the aperture.

It is preferred that the locking assembly has a pivot mount. However one skilled in the art will recognize that other mounting options may work as well. On a pivot mount, the locking assembly may have shock absorbing features to better ensure control of the overhead bin loads.

Preferably, the locking assembly of the invention includes integrated electronics for communication, for example, for indicating the locked or unlocked states of the locking assembly. Thus, integrated electronics can indicate to a user if the seat is properly located, or if the overhead storage bin is closed correctly, or if the load in the bin has shifted to a potentially dangerous point. By way of a non-limiting example, this can be effected by micro-switches. Information as to the locked or unlocked status of the locking assembly can be conveyed to an indicator light or similar indicium locating in a convenient position.

In situations where the light or other indicium indicates improper locking or location, shifting loads, or possibly an overload, a user such as a flight attendant may be summoned to manually correct the situation, so that safety is maintained.

The locking assembly is preferably biased towards the locking position, preferably by a coiled spring, positioned in the locking assembly of the invention so that the spring urges the locking assembly toward the locking position. When the material is activated, this may cause compression of the spring, which accordingly can return the locking assembly towards the locking position once the material is no longer activated.

It is preferred that the locking assembly of the invention includes additional biasing means, such as a spring, for ejecting the locking stud. Where the locking strut is included, it is included that the locking strut includes a spring or other counterbalancing means to assist in control of opening and closing of, for instance, an overhead storage unit.

The locking assembly of the invention may include many other options. One such option is the sensing of change in temperature, for example to indicate a dangerously high temperature, so that an appropriate alarm can be initiated, the locking assembly of the invention being wired into, for example, the aircraft electrical system. Other sensing functions may be incorporated in the locking assembly of the invention.

The locking assembly of the invention may include multiple materials such as shape memory alloy wire. This can provide redundancy, so that if activation of one shape memory alloy wire fails to operate the system, the other or another of the wires can be activated.

Preferably, the locking assembly of the invention includes one or more sensors which can detect whether the locking stud is present in the system, regardless of whether the locking assembly is in the locked or unlocked state. It is also preferred that the locking assembly of the invention includes lock status sensors, which can report whether the locking assembly is in the locked or unlocked state. Such sensors may act as a reed switch, for example, so that when they make contact a report is generated that the locking assembly is in the locked or unlocked state, depending on the construction of the locking assembly. The lock status sensors may also work by enabling completion of an electrical circuit. Other configurations and means of sensing may also be applicable.

The locking assembly of the invention may also include a temperature sensor for sensing the temperature of the shape memory alloy wire in the preferred embodiments. This can adjust the amount of energy applied to the shape memory alloy wire, depending on sensed temperature, to take into account varying conditions. For example, if the temperature is relatively low, a larger amount of power may need to be delivered to the shape memory alloy wire to heat it to the desired temperature. Conversely, if the temperature is high, the amount of power to be delivered to the shape memory alloy wire in order to cause it to contract may be far less. A temperature sensor can enable feedback and cause adjustment of power delivery in this regard.

In an especially preferred embodiment, the locking assembly includes a microprocessor which can carry out one or several roles. The microprocessor can control the energy delivery to the shape memory alloy wire, preferably by a temperature-dependent algorithm. The microprocessor can control temperature of the shape memory alloy wire. It can sense the state of the locking assembly and whether it is engaged or not. The microprocessor can detect whether the locking stud is present in the locking assembly. The microprocessor may report this, along with secondary sensed information, to a network of which the locking assembly forms a part. Preferably, the microprocessor carries out all these roles.

The locking assembly of this invention may also include a weight sensor for sensing the weight on an element such as a seat or inside a storage unit or to sense whether or not the weight has shifted to a possibly hazardous position. This locking assembly will provide feedback to a user as to the weight of the contents of a storage unit or on a seat. This is particularly important in aircraft where there are weight restrictions and the need to balance weight across the aircraft. If a load is overweight the locking assembly can be programmed to reject the load or can default to a position where a user needs to manually open the compartment so that the contents do not fall heavily on a user.

Airplanes are also sensitive to weight shifts. This locking system may be able to detect a shift in contents and will notify a user that manual intervention may be necessary to safely open the compartment.

In one embodiment, the locking assembly of the invention may be designed to lock the storage bin if contents have shifted dangerously, so as to prevent opening by a passenger without assistance from a flight attendant.

The locking assembly of the invention is capable of being produced at a low cost, with minimum parts and in a very small size. It is suited to high volume mass production and may be designed so as to require only low power consumption, if thin shape memory alloy wires are used.

Optionally, the locking assembly of the invention has a manual override so that the locking assembly can be released in case of a power failure or if it is required to test the locking assembly before power has been connected, for example.

Examples are shown in the drawings. The manual override may enable the shuttle to be rotated to the unlocking position, in the embodiment where the rotatable shuttle system is used. Preferably, the manual override includes means for drawing the shuttle to the unlocking position, such as a rod connected to the shuttle and a manual actuator, such as a cable. When the manual actuator is pulled, the rod causes the shuttle to move to the unlocking position.

For security, it is preferred that the drawing means is biased away from the unlocking position. For example, when the drawing means includes a rod, the rod may need to be pulled against a spring. To further protect against accidental or inadvertent release, the drawing means may include means for engagement with retaining means. The purpose of this is to ensure that the drawing means must deliberately be disengaged from the retaining means before the manual override can be operated. Both of these safety mechanisms can help to ensure that accidental manual release does not occur though vibration, for example.

The drawing means may take any other suitable form, including that of a Bowden cable.

One skilled in the art will recognize that there may be instances where a user may want to use this locking assembly in a manual fashion. This may be a case where electricity is unavailable or simply because a user desires a manual mode of releasing the lock. This invention can be capable of operation in a manual setting.

Other advantages and aspects of the present invention will become apparent upon reading the following description of the drawings and the detailed description of preferred embodiments of the invention.

### BRIEF DESCRIPTION OF THE DRAWINGS

FIG. 1 depicts a top view of a first embodiment of the locking assembly of the invention (with cutaway detail) in the unlocked position;

FIG. 2 depicts a rear view of the locking assembly of FIG. 1, showing a seat mounting bracket;

FIG. 3 depicts a front view of the locking assembly of FIG. 1;

FIG. 4 depicts a side view of the locking assembly of FIG. 1 in its locked position;

FIG. 5 depicts a front view of the locking assembly of FIG. 1 with the sealed locking unit removed;

FIG. 6 depicts a partial section of the side view of the locking assembly of FIG. 4;

FIG. 7 depicts a sectional view taken along the line A-A of FIG. 6;

FIG. 8 is a block diagram depicting an embodiment of monitoring of the FIGS. 1 to 7 embodiment of the locking assembly;

FIG. 9 shows in perspective view a storage unit incorporating a second embodiment of the locking assembly of the invention, in the locked or closed position;

FIG. 10 is a side view of the storage unit of FIG. 9, with the locking assembly in the unlocked or open position;

FIG. 11 is a side elevation of the storage unit, showing the unlocked position, but omitting a side panel for clarity;

FIG. 12 is a side elevation corresponding to FIG. 10, but omitting a side panel for clarity;

FIG. 13 is a sectional side view of the locking assembly of the second embodiment, in locked position;

FIG. 14 is a sectional side view of the locking assembly in the second embodiment in the open position;

FIG. 15 is a vertical sectional view of a third embodiment of the locking assembly of the invention, in locked position;

FIG. 16 is a vertical sectional view of the locking stud in the embodiment in FIG. 15, in the unlocked position;

FIG. 17 is an elevation of the locking stud assembly of FIG. 16;

FIG. 18 is a front view of part of the assembly of FIG. 15, showing the body retaining bracket;

FIG. 19 is a front view of the retaining bracket of FIG. 18 including the lock body of FIG. 15 and

FIG. 20 is a rear view of the assembly of FIG. 19, with a backing plate removed.

### DETAILED DESCRIPTION OF THE PREFERRED EMBODIMENTS

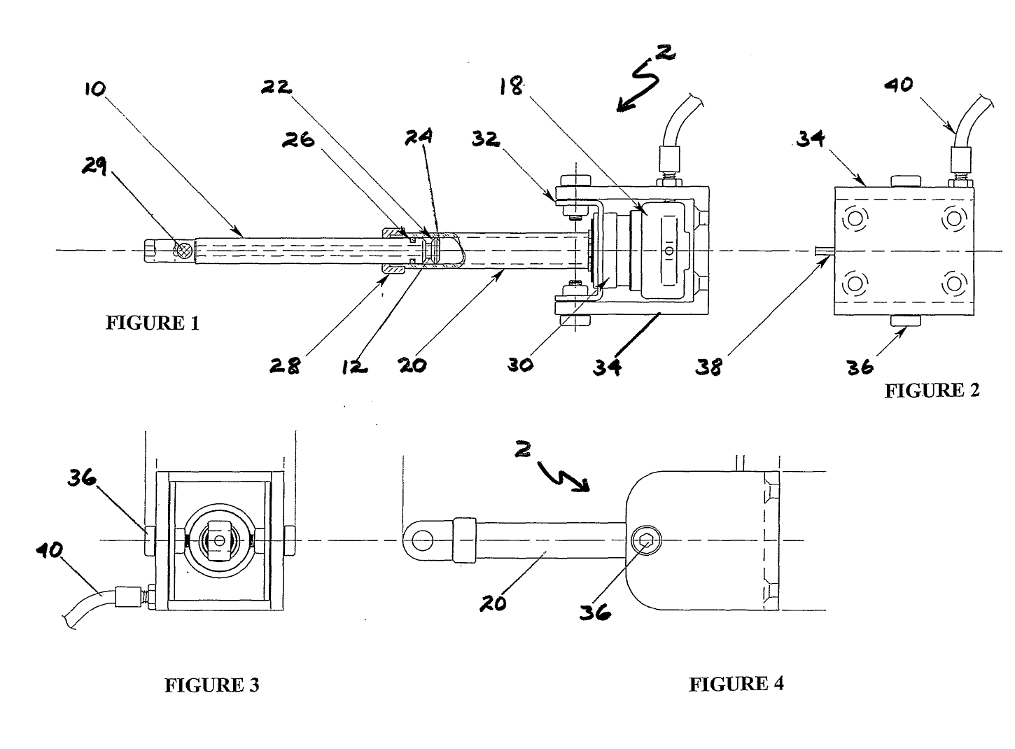

This invention in the embodiment in FIGS. 1 to 7 features a locking assembly 2 for locking or unlocking a passenger seat. Referring to FIG. 1, locking assembly 2 has a locking stud 10 having a locking cavity, namely groove 12 around its perimeter. Groove 12 has tapered walls, one of which is shown at 22. Locking stud 10 also tapers towards base 24.

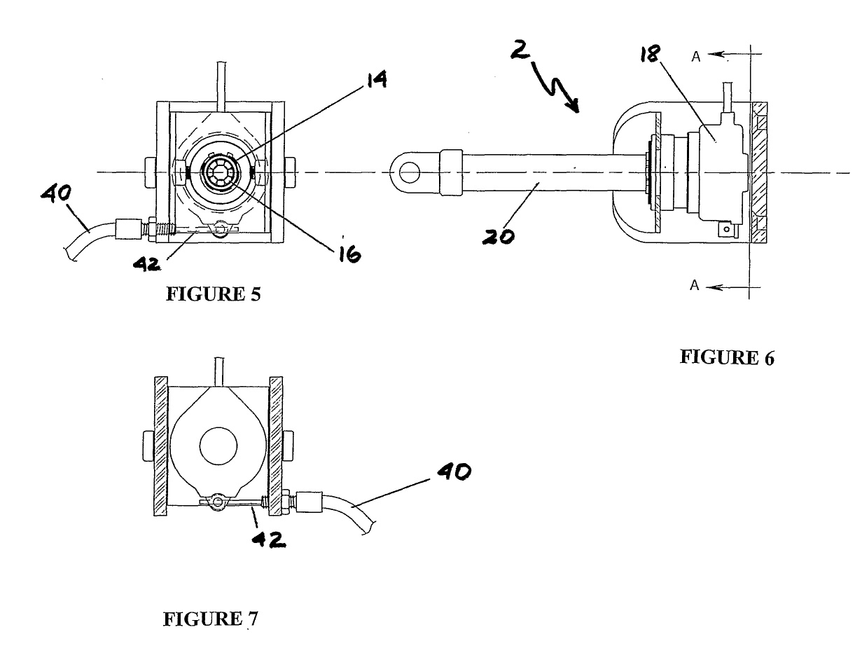

Aperture 14 in body 18 is designed to receive locking stud 10 (Refer FIG. 5).

Included in body 18 is a rotatable shuttle (not visible but illustrated in imported specification WO 2005/047714, together with shape memory alloy wire wound around the shuttle). Also included in body 18 are teeth 16 (FIG. 5) designed to enter groove 12 to lock locking stud 10, as described in the imported specification.

Locking stud 10 is slidable within locking stud guide 20 (FIGS. 1, 4 and 6). Seal 26, made of rubber, nylon or other suitable material, ensures that locking stud 10 slides in a sealing relationship with the inner walls of guide 20. End cap slide bearing 28, made of nylon or engineering grade plastic, acts as a seal and also assists the sliding action of locking stud 10. Locking stud 10 includes sintered metal filter 29. This permits air, but not water, to enter and leave locking stud 10.

Locking assembly 2 is also provided with isolation mount 30, pivot bracket 32, seat mounting bracket 34, shoulder bolt 36 (FIG. 2), electric cable 38 and manual override cable 40.

In this embodiment, it is intended that locking assembly 2 will be installed into a passenger seat on an airplane to provide passengers with a safe way of flying. The seat mounting bracket 34 provides the means for locking assembly 2 to be mounted securely within the inside of the passenger seat.

In order to ensure passenger safety, locking assembly 2 defaults to the locked position. By defaulting to this position, a passenger is ensured a safe seating arrangement during inclement weather, take-off, landing, or while taxiing.

When it is safe to release the passenger seat, locking assembly 2 can be activated to release the locked position. The command for this activation may be generated remotely, for example, at a central location on the aircraft. Upon activation, the electrical cable 38 powers movement of the shuttle within body 18. As the shuttle rotates, teeth 16 are released from engagement with groove 12 and locking stud 10 slides within locking stud guide 20 away from aperture 14 in stud locking body 18. Once disengagement has occurred, the seat is unlocked and is free to move or recline as the passenger desires.

From the unlocked position, the passenger seat can easily be brought back to its default, locked position. When a passenger or flight attendant moves the seat to the “landing” position, locking stud 10 travels through locking stud guide 20 until base 24 enters aperture 14 and teeth 16 engage groove 12. The shuttle within body 18 rotates so that teeth 16 are blocked from disengaging from groove 12. The seat is then locked in position and cannot be moved out of that position until locking stud 10 is released, remotely or otherwise.

During movement of locking stud 10 through locking stud guide 20, friction can develop which is an undesirable feature. In this embodiment, a seal is used to ease the friction. Locking stud seal 26 added to locking stud 10 solves this problem and eases the movement of locking stud 10 through locking stud guide 20.

This embodiment can avoid another problem of excess air pressure building within locking stud guide 20. As locking stud 10 is moved back and forth within locking stud guide 20, air pressure may build interfering with the ability of locking assembly 2 to move smoothly. A sintered metal filter 29 at the end of locking stud 10 eases the pressure.

The parts of this locking assembly 2 are in a sealed relationship with each other. This relationship allows locking assembly 2 to exclude contaminants such as dust, water, or other debris from interfering with its function.

The locking stud 10 and locking stud guide 20 are in a slip relationship with each other that does not allow one to disengage from the other. This slip relationship ensures auto-alignment of locking assembly 2, preventing the possibility of an incorrect connection which may compromise passenger safety and/or result in breakage.

Remote activation of this locking assembly is effected by the use of electronic packaging and a microprocessor (not depicted) embedded within locking assembly 2. The electrical cable 38 links locking assembly 2 to a power source. In the case of an airplane, the electrical cable would be receiving power from the plane's power source. The combination of the electronic packaging with the microprocessor allows locking assembly 2 to receive commands remotely and to respond based on the command.

In the case of an electrical power failure, locking assembly 2 is equipped with a manual override cable 40 that will allow a user to manually release the seat from its locked position.

A user will simply pull manual override cable 40, so that, in turn, rod 42 (FIGS. 5 and 7) connected to the shuttle is drawn to rotate the shuttle so that teeth 16 are no longer blocked. Once that occurs, locking assembly 2 will release as easily as it would when activated remotely.

It will be appreciated that the locking assembly of the invention could be used in other applications, such as to fasten a door or other closure in the open or closed position.

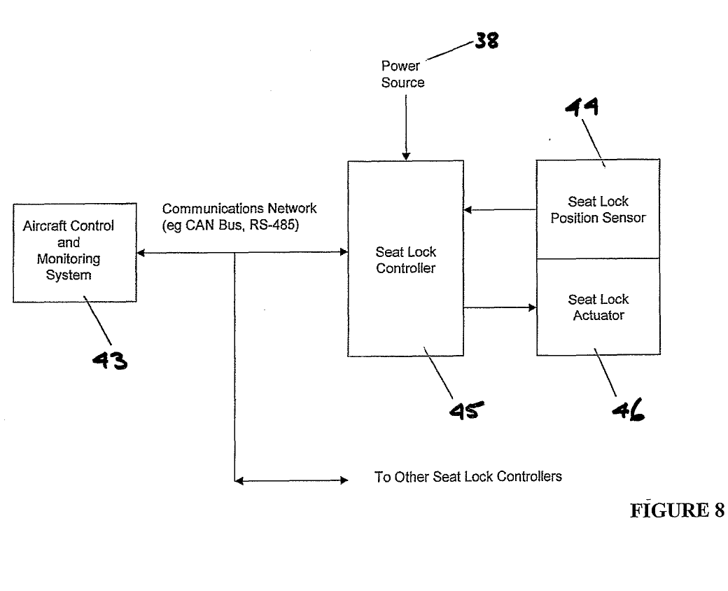

Referring now to FIG. 8, this is a block diagram which shows how the embodiment described in FIGS. 1 to 7 can be monitored and controlled. As can be seen from FIG. 8, aircraft control and monitoring system 43 can communicate, via a known network, such as a CAN bus or an RS 485 system, with seat lock controller 45. Seat lock controller may represent part of an electronic packaging with a microprocessor, as mentioned above.

Seat lock controller 45 is able to receive information from seat lock position sensor 44 and is able to command seat lock actuator 46, which in turn activates a locking assembly such as locking assembly 2 in FIGS. 1 to 7. Other locking assemblies may be substituted.

Seat lock controller 45 may be powered by power source 38, in the same way as locking assembly 2.

As shown in FIG. 8, the aircraft communications network can communicate with other seat lock controllers in the same way as with seat lock controller 45.

Using this system of monitoring and control, a central location, such as the aircraft cockpit, can be fully advised of the current situation with regard to seats and whether every seat in the aircraft is in the correct position for taxiing, take off, landing or rough weather.

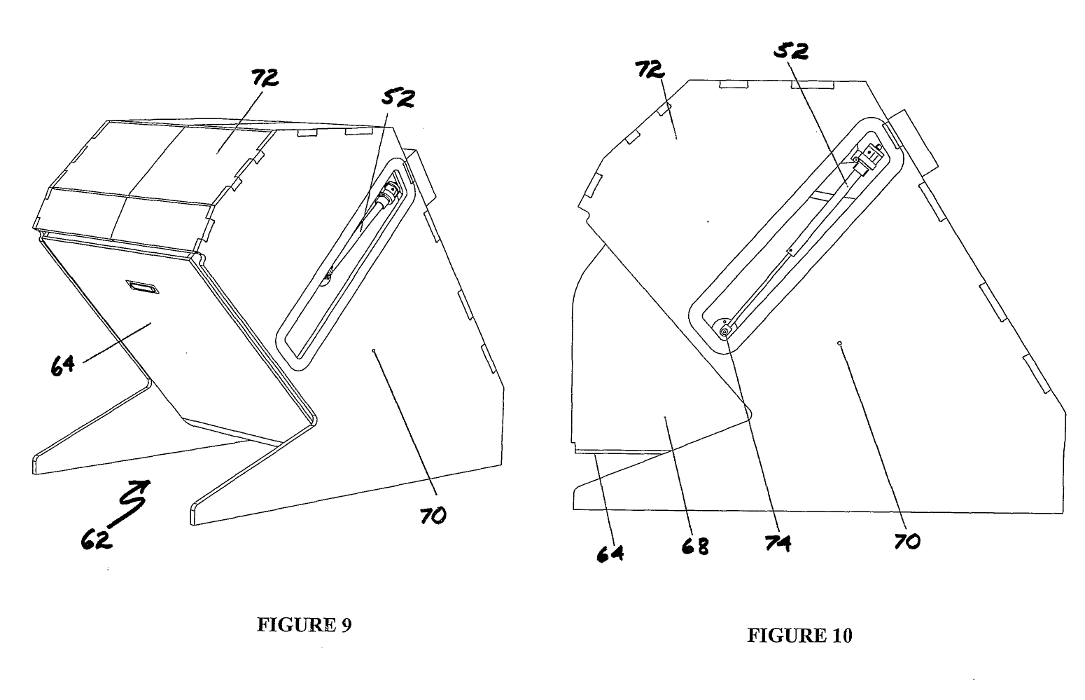

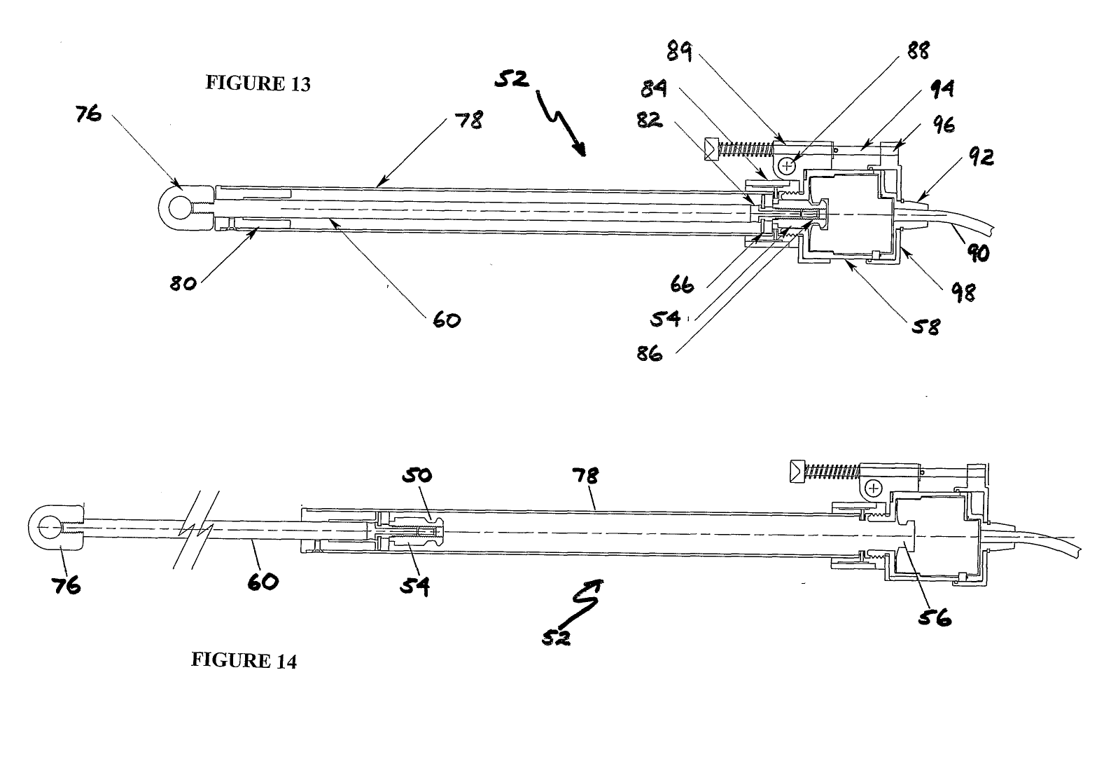

With reference to the second embodiment in FIGS. 9 to 14, locking assembly 52 is for locking or unlocking an overhead bin in an aircraft. With particular reference to FIGS. 13 and 14, locking assembly 52 has a locking stud 54 having a locking cavity, namely groove 50 around its perimeter. Groove 50 is equivalent to groove 12 in the first embodiment and will not be further described here.

Lock body 58 has aperture 56 (FIG. 14) for receiving locking stud 54. When locking stud 54 is properly inserted in aperture 56, teeth or other locking means engage groove 50, in a similar manner as already discussed.

Included in lock body 8 is unlocking means (not shown) comprising material adapted to contract when activated to allow for disengagement from aperture 56.

As can be seen from FIGS. 13 and 14, locking assembly 52 also includes locking strut or shaft 60 inside piston 66, in which locking stud 54 is slidable towards and away from aperture 56.

As can be seen in FIGS. 9 to 11, overhead storage unit 62 in an aircraft has storage bin 68, pivotable around pivot point 70. Door 64 forms part of storage bin 68.

Instead of the prior art latch for closing door 64 to bulkhead 72, overhead storage unit 62 includes locking assembly 52. Locking assembly 52 is recessed in bulkhead 72 and secured at one end to bulkhead 72 and at the other end to storage bin 68.

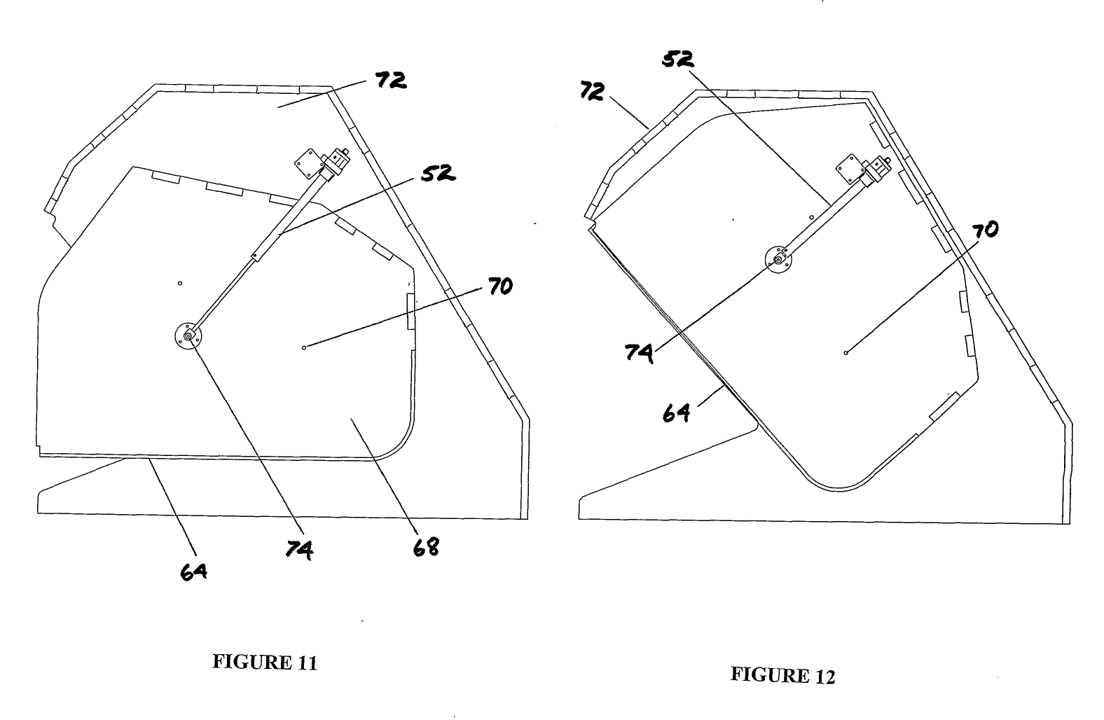

When locking assembly 52 is in the locked position, as shown in FIGS. 9 and 11, locking stud 54 is held firmly in place inside aperture 56 within lock body 58, as shown in FIG. 13. When locking assembly 52 is in the unlocked position, locking stud 54 has disengaged from aperture 56 and door 64 is open as shown in FIGS. 10 and 12. This is reflected also in FIG. 14.

As can be seen in particular from FIGS. 11 and 12, locking assembly 52 is pivotably attached to storage bin 68 at 74. FIG. 13 shows shaft attachment pivot 76 on locking assembly 52 for this purpose.

As will be seen from FIG. 13, shaft 60 and piston 66 are enclosed in cylinder sleeve 78, shaft 60 and piston 66 being slidable therein. Sleeve end plug 80 seals the end of cylinder sleeve 78 near shaft attachment pivot 76. The head of piston 66 also includes a seal. In this way, dust debris, etc, are excluded from cylinder sleeve 78, so that reciprocation of piston 66 and shaft 60 within cylinder sleeve 78 is unimpeded.

Locking assembly 52 also includes gas equaliser vent 82 and sintered gas filter 84. Gas limiting valve 86 limits the rate at which gas (e.g. air) can escape from cylinder sleeve 78.

Locking assembly 52 is fastened to bulkhead 72 by mounting pivot 88 on main mounting bracket 89.

When storage unit 62 is to be opened, locking shaft 60 applies pneumatic dampening motion by way of piston 66. Resistance is created by limiting how quickly air can escape. Typically, air will escape through gas vent 82.

To open storage unit 62 from the locked position, the material adapted to contract when activated (not shown) is activated to release locking means in lock body 58 to permit locking stud 54 to slide away from aperture 56.

When storage unit 62 is to be closed, there is minimal resistance, since the locked position is the default state.

Remote activation of locking assembly 52 is effected by use of electronic packaging and a processor (not shown) embedded within locking assembly 52. Electrical cable 90 links locking assembly 52 (through cable exit grommet 92) to a suitable power source. In the case of an airplane, electrical cable 90 would receive power from the plane's source. The combination of the electronic packaging with the processor allows locking assembly 52 to receive commands remotely and to respond based on the commands.

In the case of an electrical power failure, locking assembly 52 is equipped with a manual override plunger 94 which forms part of manual release mechanism 96. For safety, manual release overcover 98 must first be removed before a user can manipulate manual release plunger 94 to release the locking means in lock body 58. (In an alternate embodiment, manual release overcover 98 may be omitted). Once that occurs, locking assembly 52 will release as easily as it would when activated remotely.

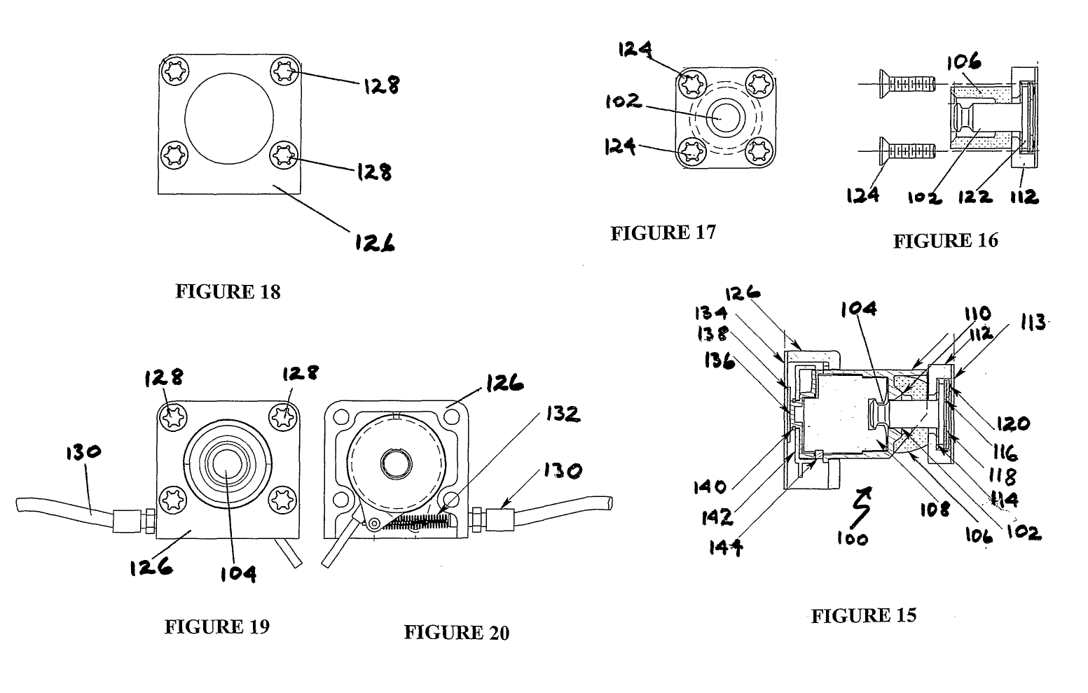

The third embodiment in FIGS. 15 to 20 features a locking assembly 100. This embodiment can illustrate an example of the small size in which the locking assembly of the invention can be provided. For example, the locking stud in FIG. 16 may have a diameter of 10 mm, with the length of the locking stud and the casing at its base being around 30 mm. The total height of the locked assembly shown in FIG. 15 is around 61 mm. In FIG. 17, each side is around 36 mm. The bracket in FIG. 18 has one side of 50 mm and the adjoining side 52 mm.

FIG. 15 shows locking stud 102 locked into aperture 104 in lock body 108. As can be seen in FIG. 16, locking stud 102 is sited within locking stud foam boot 106. FIG. 15 shows locking stud alignment cone 110 with an inclined internal surface which serves to guide locking stud 102 into aperture 104 when locking stud 102 is sufficiently close to aperture 104. In the dimensions of locking assembly 100 as set out above, the alignment tolerance between locking stud 102 and aperture 104 is plus or minus 2 mm. Alignment cone 110 is designed to capture locking stud 102 and force it to slip into correct alignment with aperture 104. Foam boot 106 is designed to spread in the locking position, as can be seen in FIG. 15. Compression of foam boot 106 in the locked position provides a drip-proof seal between locking stud 102 and lock body 108.

Visible in FIGS. 15 and 16 is casing 112 around the base of locking stud 102. Casing 112 has backing plate 113. Included in casing 112 are upper washer 114 (of Teflon or other suitable material), lower slip disc 116 (also of Teflon or other suitable material), thrust washer 118 (for example, of stainless steel) and wave washer 120. Wave washer 120 provides compression against thrust 118 onto lower slip disc 116, then against flange 122 of locking stud 102 and then against slip disc 116. This compression provides a frictional hold on locking stud 102, keeping it in position until it is forced “slip” to a new position by alignment cone 110.

Lower slip disc 116 and upper washer 114 are clamped onto locking stud flange 122, providing a frictional hold and allowing forced slip without wear.

FIG. 16 includes fasteners 124 before insertion and four of these are shown in place in FIG. 17.

As shown in FIG. 18, retaining bracket 126 has similar fasteners 128.

FIGS. 19 and 20 show manual override actuation cable 130, which must be worked against return spring 132. In FIG. 20, backing plate 134 (see FIG. 15) has been removed for clarity of illustration.

As can be seen in FIG. 15, rear lid 136 is placed at the back of lock body 108, with foam rubber 138 cushioning this from backing plate 134. Circlip 140 retains manual override shell 142. Fastening seal 144 completes the assembly.

It will be appreciated that the locking assembly of the invention may be used in other applications, such as to fasten a window or other closure in the open or closed position.

The description above relates to preferred embodiments of the present invention only and are given by way of illustration. Changes, modifications and variations may be made without departing from the spirit and scope of the present invention.

Throughout the specification and claims the word “comprise” and its derivatives when used are intended to have an inclusive rather than exclusive meaning unless the context requires otherwise.

### INDUSTRIAL APPLICABILITY

The locking assembly of the invention has ready application to many fields where locking is required, but especially in the aerospace industry, for locking and unlocking seats and containers, such as overhead bins.

1. A locking assembly comprising:
a locking stud having a locking cavity;
an aperture for receiving the locking stud;
a locking means adapted to engage the locking cavity of the locking stud when received in the aperture;
an unlocking means comprising material adapted to contract when activated to allow for disengagement from the locking cavity; and
a locking stud guide adapted to guide the locking stud towards the aperture.

2. The locking assembly of claim 1, wherein the locking cavity is a groove around the locking stud.

3. The locking assembly of claim 1, wherein the locking stud includes a taper adapted to enable the locking stud to be pushed into the aperture and be engaged therein.

4. The locking assembly of claim 3, wherein the locking stud is adapted to slide towards and away from the aperture within a piston by means of a locking strut.

5. The locking assembly of claim 4, wherein the locking stud guide is adapted to provide a sealing relationship with the locking stud.

6. The locking assembly of claim 5, which includes a seal on the locking stud to seal the locking stud with respect to the locking guide.

7. The locking assembly of claim 6, wherein the locking stud is held captive by the locking guide to prevent disengagement of the locking stud from the locking guide.

8. The locking assembly of claim 3, wherein the locking stud guide forms a cone or ramp adapted to guide the locking stud into the aperture.

9. The locking assembly of claim 8, which includes a microprocessor.

10. The locking assembly of claim 9, wherein the microprocessor is adapted to indicate one or more of the following:
locked or unlocked status of the locking assembly, presence of the locking stud and temperature of the material adapted to contract when activated.

11. The locking assembly of claim 10, which includes a reed switch.

12. The locking assembly of claim 11, wherein the material adapted to contract when activated is shape memory alloy wire.

13. The locking assembly of claim 12, wherein the shape memory alloy wire is activatable by electrical resistance heating.

14. The locking assembly of claim 13, which includes a wire feed to the locking assembly to effect electrical resistance heating.

15. The locking assembly of claim 13, which includes remote means to effect electrical resistance heating.

16. The locking assembly of claim 15, wherein the remote means is a hand tool adapted to operate through energy chosen from the group: microwave, electromagnetic, magnetic, sonic, infrared and radio frequency energy.

17. The locking assembly of claim 16, which includes more than one shape memory alloy wire.

18. The locking assembly of claim 17, wherein the locking means comprises a variety of teeth surrounded by a rotatable shuttle and the shape memory alloy wire is wound around the shuttle.

19. The locking assembly of claim 18, in which the shape memory alloy wire is attached at one end of the shuttle and at another end to a non-rotatable part of the locking assembly.

20. The locking assembly of claim 19, which includes a second shape memory alloy wire connected at one end of the shuttle and at another end to a non-rotatable part of the locking assembly.

21. The locking assembly of claim 20, when biased towards the locked position.

22. The locking assembly of claim 21, which includes biasing means for ejecting the locking stud after disengagement.

23. The locking assembly of claim 22, which includes means to sense a change in an ambient condition.

24. The locking assembly of claim 23, wherein the ambient condition is temperature.

25. The locking assembly of claim 24, which includes a weight sensor to sense weight on an element to which the locking assembly is attached.

26. The locking assembly of claim 25, which includes a manual override.

27. The locking assembly of claim 26, wherein the manual override is adapted to move the locking means to a position where the locking stud is disengaged.

28. The locking assembly of claim 27, wherein the manual override is biased away from a position where the locking stud is disengaged.

29. The locking assembly of claim 28, wherein the manual override includes a Bowden cable.

30. The locking assembly of claim 29, when attached to an aircraft seat or an aircraft storage bin.

31. (canceled)
